(19) United States
(12) Patent Application Publication
(10) Pub. No.: US 2011/0140899 A1
(43) Pub. Date: Jun. 16, 2011

(54) Temperature measuring instrument with audio feedback

(76) Inventor: Daniel E. Flandin, Surrey (CA)

(21) Appl. No.: 12/653,403

(22) Filed: Dec. 14, 2009

(51) Int. Cl. G08B 17/00

(52) U.S. Cl. 340/584

(57) ABSTRACT

The combination is that of a temperature measuring device with a built-in variable audio signal output to quickly differentiate between and locate cold or hot spots and zones in applications for temperature measurements. Temperature measurements may be performed by means of solid state temperature measuring devices, thermocouples, infrared sensors, thermistors, RTD's, or any heat sensing or temperature measuring device. The audio signal output in the device will vary in tone or modulation in order to signal a cold or hot spot or zone being detected on the object undergoing temperature measurement.

### BACKGROUND OF THE INVENTION

The present invention relates to temperature measuring instruments utilizing both contact and non-contact technology and, more particularly, to a temperature measuring device adapted to quickly detect, locate and produce feedback on any cold or hot spots and zones found on an object as compared to a reference temperature.

Prior art temperature measuring devices require a wide array of tests and experiments be conducted including temperature measurements at several points on the object, data logging, tabulation and interpretation of the data in order to determine a hot or cold spot and zone as compared to a reference temperature set on the object.

Undetected temperature fluctuations of critical components, for example, in an electronic or mechanical assembly or any other object, may cause field failure with severe consequences in many applications such as used in avionics, automotive, industrial, marine, agricultural, power plant maintenance and other industries and applications.

Detected temperature fluctuations on an object such as described above can be used to diagnose problems quickly and reliably thus avoiding possible equipment failure and field accidents. An example of this, would the detection of restricted radiator cores in heating/cooling equipment, where a restricted radiator core may cause an explosion in the radiator due to hot vapor build up.

Another example would entail the scanning of live electrical wires and harnesses to detect any hot spots caused by an electrical wiring fault, thus avoiding a possible short circuit of the wires which could present a risk of fire or other damages if not attended to.

The uses of the proposed new art measuring instrument are innumerable and the above examples illustrate only a couple of such applications.

As can be seen, there exists a need in the art for a temperature measuring device capable of providing quick, reliable and intuitive feedback in locating such cold or hot spots and zones by detecting temperature deviations from a set temperature point on an object.

### BRIEF SUMMARY OF THE INVENTION

Provided is a uniquely configured temperature measuring device to quickly identify, detect and locate cold and/or hot spots and zones in any object undergoing temperature measurement. While utilizing a sensor for the detection of heat sources in a temperature measuring device is an existing art, the coupling of such a device to an audio signal output is a novel means of quickly identifying and locating such cold or hot spots and zones in objects.

In its broadest sense, the instrument could be hand held or stationary and comprises a microprocessor or microcontroller, a voltage regulator, a keypad, a display, an audio transducer, a battery, an analog to digital converter, a thermopile sensor or other temperature sensor and an internal temperature sensor. The temperature measuring device is configured to process information through the microcontroller by setting the initial measured temperature on an object or to be manually selected via, for example, the keypad as its set point reference temperature or a preselected temperature.

Using this set-point reference temperature, the microcontroller further emits an audible sound through the audio transducer identifying the set-point temperature reference, which could be an area or a spot of the object under test. Any deviation in temperature from this set-point temperature reference during temperature measurements of the object will then be identified by a different tone of sound generated through the audio transducer as driven by the microcontroller during the measurement process, thus quickly identifying either a drop or rise in temperature, in a particular spot or zone on the object being tested for temperature.

It is, in general, the object of the invention to provide a new method of identifying and detecting a cold and/or a hot spot or zone in an object under temperature measurement tests in order to identify possible equipment failure caused by temperature fluctuations on a specific object.

### BRIEF DESCRIPTION OF THE DRAWING

FIG. 1 is a block diagram of a temperature measuring device of the present invention and illustrates a microprocessor/microcontroller, a voltage regulator, a keypad, a display, an audio transducer, a battery, an analog to digital converter, a thermopile sensor, an internal temperature sensor and a thermocouple.

### DETAILED DESCRIPTION OF THE INVENTION

Referring now to the drawing wherein the showing is for the purpose of illustrating the various aspects of the invention and not for the purpose of limiting the same, provided is a uniquely configured temperature measuring device that is specifically adapted to provide for quick audible detection of cold and/or hot spots and zones on an object undergoing temperature measurement tests while also providing for standard temperature measurements shown on a display. The temperature measuring device is uniquely configured to advantageously allow for the collection of temperature data during temperature measurement tests and to audibly detect any cold or hot spots or zones on the object being tested.

More specifically, the temperature measuring device is specifically designed and configured to provide an instrument of the above character which provides compensation for different scales of measurement thus allowing the audio output signal to vary in accordance with low and high temperature readings and to quickly determine via the audio signal output where a hot or cold spot or zone might exist on the object. The unique configuration of the temperature measuring device eliminates the need for lengthy and time consuming experiments involving the laborious task of taking several temperature readings on an object, tabulating them and running comparative studies to determine where and if a cold or hot spot or zone exists on the object under temperature measurement test.

As was mentioned earlier, the presented temperature measurement instrument is a novel device that provides quick and intuitive feedback in locating areas, spots and zones in which temperatures deviate from a set-point reference temperature in an object or objects. It is specifically designed to be used in temperature measuring applications where the temperature measuring instrument is either a hand held or stationary instrument using either a contact sensor or a non-contact technology such as for example, infrared radiation for remote temperature measurements or a combination of heat sensors.

The reference temperature for the device is set at a chosen level by simply measuring any part of the object temperature or by manually entering the temperature value via a keypad and deviations from that set-point reference temperature are indicated by a varying audio tone, the modulation of the audio tone or a combination thereof.

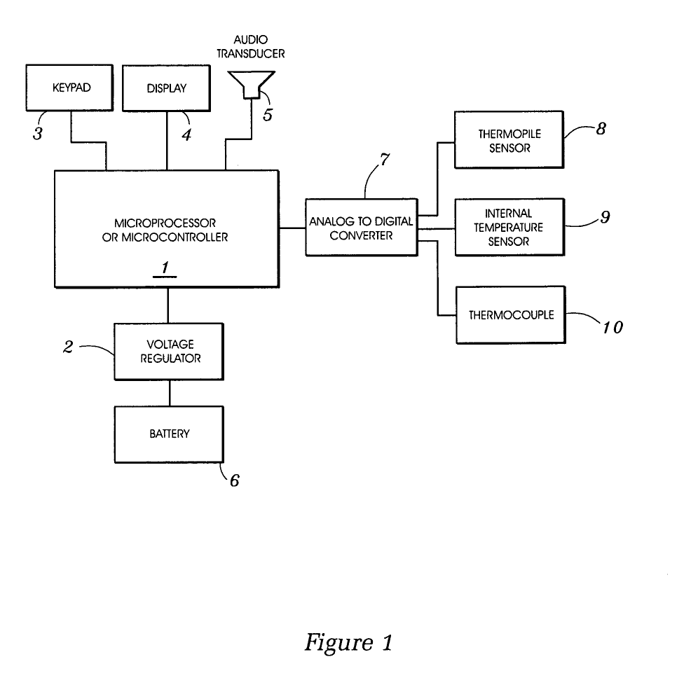

The temperature measuring device as shown in FIG. 1, comprises a microprocessor 1, a voltage regulator 2, a keypad 3, a display 4, an audio transducer 5, a battery 6, an analog to digital converter 7, a thermopile sensor 8, an internal temperature sensor 9 and a thermocouple 10.

More specifically, this temperature measuring device consists of a microcontroller 1 (Or microprocessor) powered by a voltage regulator 2 and a battery 6. The microcontroller is in charge of coordinating all the tasks and of measuring and processing information such as receiving user inputs through a keypad 3, providing the user with information and feedback through the display 4 and the audio transducer 5, and measuring through the analog to digital converter 7, the signal outputs from the thermopile sensor 8, the internal temperature 9 and the thermocouple 10. The microcontroller 1, using either an internal or external analog to digital converter 7 which may or may not be needed depending on the type of temperature sensor being used, measures the voltage from the internal temperature sensor 9 and from the thermopile sensor 8 or the thermocouple 10. The voltages measured are then processed by the microcontroller 1, translating these measurements through the use of mathematical formulas, look up tables or both into temperatures that are shown on the display 4.

Referring more particularly to FIG. 1, the microcontroller 1, upon receiving an input from the user (ie Keypad 3), sets the actual measured temperature as its set-point reference temperature, and subsequently calculates the difference between the new measured temperature and the set-point reference temperature. Using this information, the microcontroller 1, generates an audible sound through the audio transducer 5, in which the tone or tone modulation is adjusted or changed according to the difference between the reference and the actual temperature measurement. For example, if the measurement of temperature is carried out using the thermopile sensor 8, (as used in infrared temperature measurements), the user selects an area or object with the desired temperature which is shown on the display 4, and then presses a designated button on the keypad 3. This action causes the microcontroller 1, to set the reference temperature and emit a sound through the audio transducer 5, with a specific tone or tone modulation. In subsequent temperature measurements on the object, the microcontroller 1, calculates the difference between the reference set-point and the new measurement, and adjusts the tone or tone modulation proportionally or by some other mathematical relationship to the difference between the reference set-point and the new temperature measured. To provide for a quick and intuitive feedback, the tone or tone modulation of the sound can be made to proportionally or by some other mathematical relationship to decrease in tone or tone modulation for lower than set-point reference temperatures and conversely to increase in frequency for higher that set-point reference temperatures.

What is claimed is:

1- A temperature measuring device incorporating an audio signal output which uses sounds to help the user to identify and locate temperature variations, or cold or hot spots or zones on an object.

2- The device of claim 1 further including an audio signal output which uses infrared radiation, thermocouples, thermistors, RTD's, or other kinds of heat sensing or temperature measuring devices to measure temperature.

3- The device of claim 1 or claim 2 further including an audio signal output which varies in tone, tone modulation or the combination thereof to indicate variations of measured temperature from a set-point temperature reference.

4- The device in claim 3 further including an audio signal output which varies in tone, tone modulation or a combination thereof in accordance to a mathematical relationship or values from a look-up table with the temperature difference between the set-point reference temperature and the actual temperature being measured.

5- The device in claim 1 further incorporating an audio signal output, in which the audio output is generated by a piezoelectric transducer, an electromagnetic transducer, a speaker or other type of audio transducers.

6- The device in claim 5 further providing a connector for the user to connect to an audio transducer either directly or through an audio amplifier like but not limited to a headphone or a speaker.

7- The device in claim 1 or claim 5 further incorporating and audio signal output in which the audio output is transmitted, encoded or not, by some wireless means like but not limited to radio waves or infrared signals.

8- The device in claim 7 wherein the wireless means can be transmitted either in an analog or digital format to a remote receiver which then converts the signal to an audio output through an audio transducer like but not limited to a headphone, speaker or similar devices.

9- The device in claim 1 may, or may not, further incorporate a display for the temperature readout.

10- The device in claim 1 and claim 2 may incorporate a combination of temperature sensors including infrared sensors, thermocouples, thermistors, RTD's, or other sensors to measure temperatures.
